(19) United States
(12) Patent Application Publication
(10) Pub. No.: US 2024/0427440 A1
(43) Pub. Date: Dec. 26, 2024

(54) Mr. Medi mouse #2

(71) Applicant: Perry Marc Perlman, Wellington, FL (US)

(72) Inventor: Perry Marc Perlman, Wellington, FL (US)

(21) Appl. No.: 18/445,280

(22) Filed: Jun. 21, 2023

(51) Int. Cl. G06F 3/039; G06F 3/0354

(52) U.S. Cl. CPC G06F 3/039; G06F 3/03543

(57) ABSTRACT

A hand and wrist support device for use in conjunction with a computer pointing controlling device, including an ergonomic, support body to support a hand and a wrist of a user, an oval shaped lowest level flat staging area for the future mounting of any computer mouse pointing device, a custom fitted and nested cushion, gel pad material inserted on a top of the ergonomic support body, wherein said gel pad material is installed into a predetermined recessed area of the support body.

### CROSS-REFERENCE TO RELATED APPLICATIONS

Not applicable

### BACKGROUND OF THE INVENTION

Currently available computer pointing mouse devices do not adequately support users suffering from carpal tunnel syndrome. Therefore, there exists a need for devices that address the issues with the prior art, and specifically for computer pointing mouse devices designed for users suffering from carpal tunnel syndrome.

### BRIEF SUMMARY OF THE INVENTION

A redesign of Mr. Medi Mouse eliminates the need to purchase a special computer mouse pointing device. The re-designed hand and wrist support is manufactured with an oval shaped racetrack staging area, whereby any optical eye of a computer mouse pointing device has an unobstructive view. The newly added oval racetrack shaped staging and installation area, designed for the placement of the carpal tunnel syndrome sufferer's computer pointing mouse device.

### BRIEF DESCRIPTION OF THE SEVERAL VIEWS OF THE DRAWINGS

FIG. 1 shows a perspective view of the inventive hand and wrist support.

FIG. 2 shows a perspective view of the underside of the inventive hand and wrist support.

FIG. 3 shows a side view of the inventive hand and wrist support.

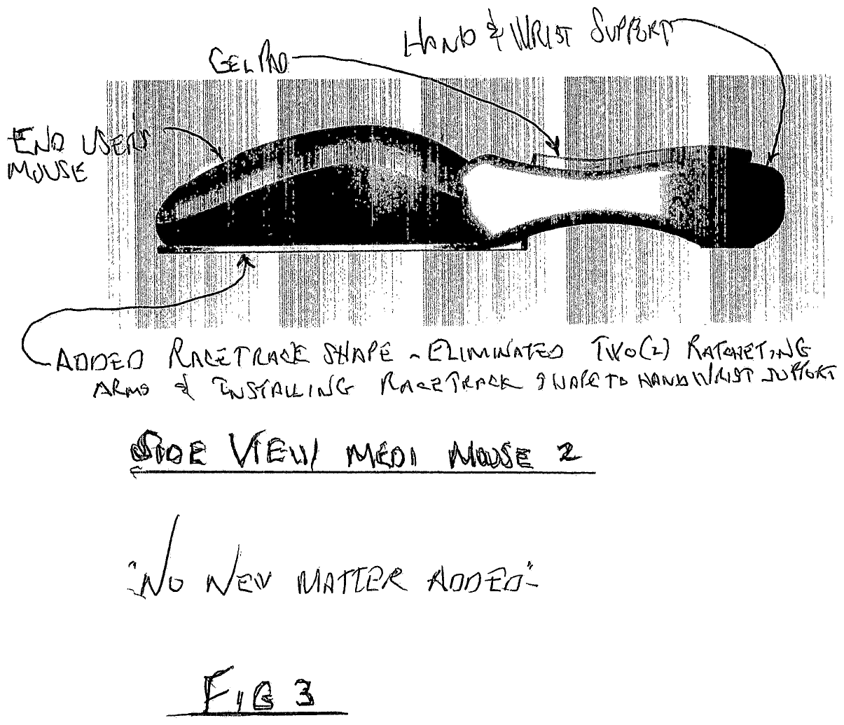

### DETAILED DESCRIPTION OF THE INVENTION

The current invention is directed to a hand, wrist, and palm support of either hand including a mounting body that is used in conjunction with an end user's computer mouse pointing device, which is installed upon the lowest level flat surface area of a racetrack oval shaped area, by means of either a two (2) sided adhesive tape or similar like material.

The end user's computer mouse pointing device is to be installed upon the racetrack oval shaped area of the oval shaped racetrack like platform area location by the means using a two-sided adhesive tape material, or similar adhesive like material, in order to secure and marry both the computer mouse pointing device.

The hand and wrist support is accompanied with a gel pad installed in the main body of the hand and wrist support. The redesign includes an oval track shaped addition which is an integral part of the hand and wrist support. The computer mouse pointing device is coupled with the flat racetrack shape, of the hand and wrist support, by means of a very thin, two-sided adhesive tape. of slide friction, that may be generated when the end user utilizes the computer mouse pointing device in combination with the hand and wrist support main body.

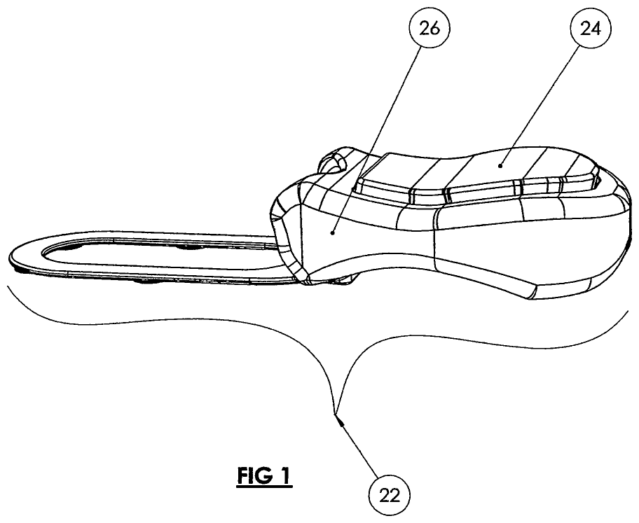

As shown in FIG. 1, 22 is an overall drawing of the hand and wrist support including the newly added “race-track” oval shaped lowest level flat staging area for the future mounting of any computer mouse pointing device by means of a two-sided adhesive tape like material.

24 is a gel pad seated into a recessed exact shaped area on top of the hand and wrist support mounting area. The gel pad serves in providing a comfortable location assisting the user in keeping his or her hand and palm in a neutral like attitude and eliminating, if possible, putting any stress of discomfort to the median nerve, that travels through the wrist area and ultimately serves the carpal tunnel digits in the end users (CTSD) hand.

26 is the hand and wrist support mounting area which also includes the addition of the newly added race-track oval shaped areas for the future installation of the end user's computer mouse pointing which is installed upon the lowest level staging flat platform surface.

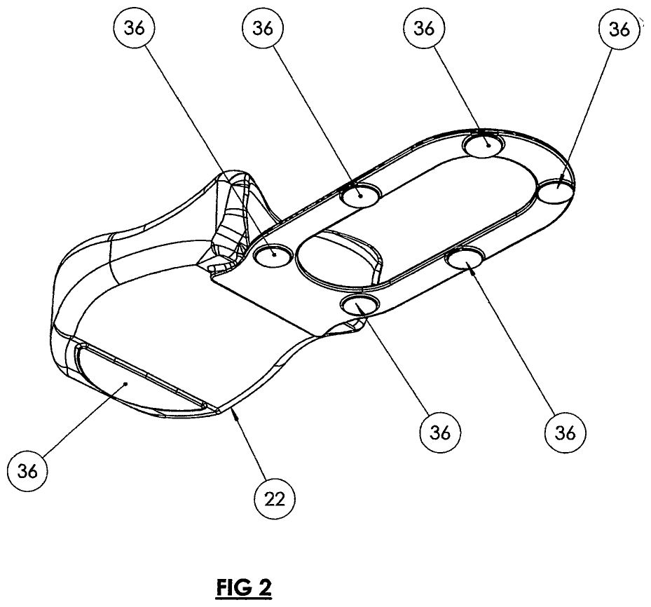

As shown in FIG. 2, 22 is an overall drawing of the hand and wrist support including the newly added “race-track” oval shaped lowest level flat staging area for the future mounting of any computer mouse pointing device by means of a two-sided adhesive tape like material. Elements 36 are areas of additional same materials added on to the hand and wrist support in order to lessen the amount of friction that may be caused when the end user in combination with a computer mouse pointing device, when installed upon the lowest flat staging location of this platform like area. The total areas where additional same-like materials have been added to the main body of the hand and wrist support shall slightly elevate the hand and wrist support above the flat surface of a desk or table, in order to minimize the amount of slide friction.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A hand and wrist support device configured to be used in conjunction with a computer pointing controlling device, said hand and wrist support device comprising:
an ergonomic, support body configured to support a hand and a wrist of a user;
an oval track extending from one end of the support body, the track circumscribing an oval void, the track configured for mounting of a computer mouse;
a custom fitted and nested cushion, gel pad material inserted on a top of the ergonomic support body;
wherein said gel pad material is installed into a predetermined recessed area of the support body.

14. (canceled)

15. The hand and wrist support device according to claim 13, wherein a plurality of friction reducing elements are disposed on a lower surface of the flat, elliptical staging area.

16. The hand and wrist support device according to claim 15, wherein a two-sided adhesive tape is applied to a top surface of the flat, elliptical staging area, said two-sided adhesive tape configured to immovably hold the computer pointing controlling device with respect to the ergonomic, support body.

17. The hand and wrist support device according to claim 16, wherein an additional friction reducing element is disposed on a lower surface of the ergonomic support body.
